(19) United States
(12) Patent Application Publication
(10) Pub. No.: US 2004/0186782 A1
(43) Pub. Date: Sep. 23, 2004

(54) Custom food

(76) Inventor: Andrew Schydlowsky, Santa Barbara, CA (US)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 10/697,767

(22) Filed: Oct. 30, 2003

Related U.S. Application Data
(60) Provisional application No. 60/456,900, filed on Mar. 21, 2003.

(51) Int. Cl. G06F 17/60

(52) U.S. Cl. 705/15; 705/16

(57) ABSTRACT

A method of offering customizable food comprising providing a base item; providing an array of additives compatible for combining with the base item, wherein addition of at least one additive from said array of additives to said base item alters a characteristic of the base item; and allowing a user to obtain the base item and at least one additive from the array, wherein the quantity of additives in said array of additives is a number greater than one.

### CROSS REFERENCE TO RELATED APPLICATION

This application claims priority to U.S. Provisional Application No. 60/456,900, which was filed on Mar. 21, 2003 and entitled CUSTOM FOOD.

### TECHNICAL FIELD

This invention relates to food products, and more particularly to customized food products and systems for selling them.

### BACKGROUND

A variety of additives are included in food products, ranging from flavorants, colorants, preservatives, texturizers, and the like. Most, if not all of these, are generally pre-added to the food product at the time of preparation or manufacturing so that the food item is distributed and marketed specifically as having the particular flavor, taste, shelf-life, etc. For example, a carton of chocolate milk is typically provided having chocolate or cocoa flavorant mixed into milk, along with an amount of preservative and possibly coloring agents. Strawberry-flavored milk is also presented in similar fashion, where the reddish or pinkish color is achieved by the addition of appropriate edible colorants, and the strawberry flavor is added by including fruit flavorants into the mixture.

Flavors or flavor enhancers are often used to disguise or overcome an unpalatable, naturally occurring taste. For example, liquid medicines, often include an active ingredient known to have a bitter taste. Children would have difficulty consuming a bitter formulation, therefore manufacturers will sweeten, flavor (e.g. grape, bubble gum, orange, etch), and sometimes color the composition. Another reason for enhancing food with flavorants or other additives is to entice a wider range of consumers.

A limitation to these products with pre-mixed additives, however, is that a consumer would need to purchase multiple items of similar products but in different varieties, in order to satisfy their desire or taste for different flavors, different colors, different textures, or even different shelf life. For example, a parent of a set of siblings, each of whom have different ideas of what is palatable, would need to purchase at least two different bottles of, for example, cough syrup—one having a fruit flavor, and one having a bubble gum flavor.

Certain manufacturers have attempted to satisfy customers needing multiple varieties by packaging an assortment of the same product in a collection or cluster. For example packets of assorted flavored oatmeal can be found in one box, or multiple boxes of small individual-sized cereals are sold as a single product when the boxes are shrink-wrapped together. Assortment collections such as these, however, can add printing, processing, and other costs to a process. Furthermore, certain flavors included in the assortment may not necessarily be the flavors desired by the consumer, and therefore go uneaten or unused.

What is desirable is a product and/or system that allows a consumer to vary or modify the consumable (e.g. food, drink, etc.) at the consumer's whim (e.g. as needed or desired), as a custom, do-it-yourself product while minimizing the inconvenience of either purchasing multiple versions of the same product, or having to seek components of a final product, which so often, are not located within a convenient distance.

### SUMMARY

The invention, in exemplary embodiments, provides customizable kits and systems that provide edible products that can be enhanced by the inclusion of an additive.

In an aspect, a kit for making a flavored nutritional supplement is provided that includes a dietary supplement product, and at least one additive. The additive can be packaged separately from the dietary supplement product.

In another aspect, a kit for making an edible item is provided that includes an edible item, and at least one additive, where the additive is packaged separately from the edible item. The additive can be combined with the edible item, at a time after the manufacture of both the edible item and the additive, and thereby alters a characteristic of the edible item.

In a further aspect, a method of selling a product includes providing a first display of a plurality of edible products; providing a second display of a plurality of packages, each package comprising an additive that alters a characteristic of the edible product when the additive is combined with the edible product; and providing a holder attachable to at least one edible product, wherein the holder is dimensioned to fit at least one package of additive.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A is an illustration of a packaged article according to an embodiment of the invention.

FIG. 1B is an illustration of another packaging alternative according to an embodiment of the invention.

FIG. 2 is an illustration of an exemplary package for an additive according to the invention.

FIG. 3 is an illustration of a display according to an embodiment of the invention.

### DETAILED DESCRIPTION OF ILLUSTRATIVE EMBODIMENTS

Certain embodiments of the invention provide a product that allows a consumer or user to customize one or more characteristics of the product's edible component according to the user's personal desire. Customizing an edible component or item, herein referred to as a “base,” can be accomplished by providing an additive suitable for combining with the base consumable.

According to an aspect of the invention, a product adapted as a kit can be provided, packaged to include a “plain” base item. A base or base item can preferably have its main constituents, yet has the capacity to be combined or blended with an additive to achieve a custom enhanced product. An illustrative example of a product within the scope of the invention is kit that includes a large bottle of marinate as a base item, having its main constituents of water, oil, vinegar and certain spices. The volume of marinate is intended to provide three marinates, each marinate being enough for a kilogram of meat or poultry. The kit would further include, for example, at least one additive such as a pouch of soy sauce, a vial of balsamic vinegar, a container of brown sugar, or a packet of shredded lemon peel. By providing at least one, but preferably more additive packages, a variety of marinates can therefore be made from the single bottle of “plain” marinate—combining one or more of the additive ingredients can provide three different marinates. In a further example, a dietary supplement base such as a muscle building or protein powder, can include a powder having the peptides, proteins or amino acids and other active constituents, or combinations thereof. Separately packaged, and optionally carried or packaged in combination with the powder, are additives such as a flavoring system that includes one or more types of flavor that can be combined with the protein powder. Preferably, one packet of flavoring can correspond to one serving of product.

Base items that can be enhanced in certain products of the invention include for example, but are certainly not limited to, medicines, dietary supplements, liquid condiments, soups, cereals, meats (including poultry, fish, shellfish, etc.), dairy and non-dairy (e.g. yogurt) items. Generally, any edible grocery item can be a base item, so long as it can be combined with and/or enhanced by a compatible additive. The base can be provided in any form such as a solid, semi-solid, liquid, or powder.

As used herein, an “additive” refers to a class of components that can be included in an edible composition that would alter directly or indirectly, a characteristic of the base. Exemplary characteristics include, but are not limited to, the flavor, color, shelf life, concentration, durability, texture, and dimension (e.g. volume, length, density, weight) of the base item. Additives suitable for combining with a base item therefore include, for example, flavorants, colorants, preservatives, texturizers, sweeteners, and combinations thereof. Alternative additives can be active constituents of a base consumable itself, whereby the inclusion of an additive to the base item increases the concentration of an active ingredient, or introduces a new benefit to the product. For example, a dietary supplement that typically includes actives such as carbohydrates, proteins, amino acids, and peptides can be provided without such active ingredients, and instead package the active constituents as additives for inclusion by the consumer at a later time after purchase. Thus, suitable additives can also include, but are not limited to, nutraceuticals (e.g. vitamins, minerals), pharmaceuticals, nutrients, herbs, carbohydrates, electrolytes, peptides, proteins, amino acids, other ingredients that impart positive health value, and combinations thereof. An additive can also be, for example, baking or cooking ingredients, such as fruits, nuts, chocolate chips, marshmallows, decorative items (e.g. pastry decorations), and the like. The additive can be provided in any suitable form that allows it to be added to the base consumable. Thus, the additive can be, for example, in a solid, semi-solid, gel-like, liquid, or powder form. Altering or modifying a base with an additive may be conspicuous or inconspicuous, mild or drastic, or anywhere within such continuums.

The additive can be added to the base consumable using various techniques, such as, for example, combining, coating, admixing, applying, or combinations thereof. Preferred techniques are those that require minimal equipment or appliances and minimal time, for the convenience of the user. For example, simply mixing the additive with a spoon, or spreading the additive with a knife are convenient methods. However, rapid mixing with a blender or mixer can also be used, if desired.

According to exemplary articles of the invention, a product is provided that comprises a base consumable and at least one additive packaged separately from the base consumable. The product can thereby be distributed, offered, sold or purchased as a single item having a plurality of components therein. It is contemplated that the additive package can be physically attached to the base consumable or the base consumable's own packaging. The attachment is preferably removable so that an additive can be conveniently detached, opened, and then combined with the base consumable.

The total amount of additive, whether provided in separate apportioned packages or in a single package, is preferably sufficient to enhance or modify (a characteristic) of an entire amount of the base consumable. As a simple illustrative example, a jar having 100 milliliters of liquid, where one serving is intended to be 10 mL of liquid, can be packaged with 10 flavor packets. Each flavor packet can contain an effective amount of flavor to achieve a desired flavor once it is combined with the liquid. Each of the flavor packets can all be the same flavor, but conveniently, they can be a variety or an assortment of flavors individually packaged. Alternatively, one or more additives can be provided in separately contained pre-measured packages. For example, in the embodiment just described, the packages can contain 5 flavor packets, 3 colorant packets, and 2 packets of gelling agents. The contents of these packets can also be provided so that they are also compatible for combining with each other.

Optionally, an additive can be packaged with a base consumable using a holder attached to the base consumable's container, or integrally part of the container. The holder can be dimensioned to carry a specific number of additive packages. An exemplary holder can be a bag that hangs from the neck of a bottle, or a sturdy container configured to hold both the base consumable and additive packages. Preferably it can be convenient for a holder to be adapted to hold a quantity of additive packages useful for the total number of servings or the total weight or volume of the base consumable.

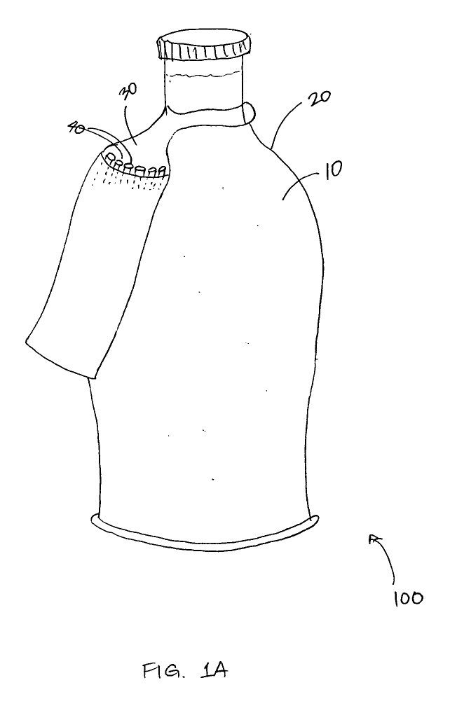

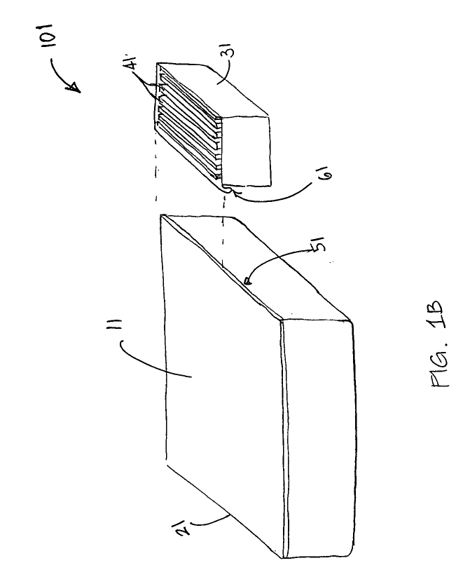

Referring now to FIG. 1A, a customizable food product 100 according to an embodiment of the invention is illustrated. Product 100 includes a base 10 contained within a container 20. A holder 30, can be removably attached to container 20. This non-limiting example of a product design according to the invention therefore allows a user, purchaser or consumer to pick and choose (and/or purchase) which additives are desirably combinable with base 10. Packaged product 100 can be designed so that it is suitable for placing one or more packaged additives 40 in holder 30—additives chosen by, for example, the consumer or pre-selected by the manufacturer or retailer. Another alternative packaging design for a product according to the invention is depicted in FIG. 1B, where a base item 11 is held within container 21 and a second container 31 holding packaged additives 41 can be removable attached to container 21. Container 31 can be attached to container 21 by any known method or technique such as, but not limited to, locking, hanging, sliding, adhering using adhesive, snapping, etc. In FIG. 1B, a lip 61 of container 31 can be hung from a side or lip 51 of base item container 21. Optionally, more than one package 31 can be positioned adjacent to base item container 21, such as by placing another package similar to that of container section 31 on another side or lip of container 21. In another embodiment, a product of the invention can be packaged in a container where container sections 21 and 31 are manufactured or formed together, such as in a uni-body design.

Additives can be provided in individualized pre-determined portions. Pre-measured amounts, for example, can be provided suitable for portioned servings, such as single servings or family size. Amounts of pre-measured additive can also correlate to effective amounts for achieving a desired alteration of the base consumable. For example, an effective amount of edible preservative packaged with a liquid base item to enhance the liquid's shelf stability can be a pre-measured additive. One additive package could therefore be combined with a specified amount of base liquid to provide a product that can be shelf stable for 2 days, for example; while another additive package containing a different amount or type of preservative can be used to provide a product whose shelf life is one week, for example. Such a system provides custom made-to-order-like formulations that can satisfy a user's need to have varying types of liquid that can he or she can prepare ranging from well in advance, to within moments of using the product.

Various packaging configurations can be used to contain an additive. The additive can be packaged alone or in combination with the base consumable. In an aspect, an additive can be provided in a package having tear-away portions that leave unused portions in tact while a portion is separated for immediate use. Other options include, without limitation, packets, vials, pouches, capsules, envelopes, cartons, tubes, jars, bottles, and the like. These can be bundled, contained, taped, hooked, glued, or tied together.

In certain embodiments of the invention, a kit according to the invention includes a base consumable that can be classified as a dry good. This class can include foods such as oatmeal, cereals, dietary supplements, and other typically non-perishable items or dehydrated foods. The base consumable can be a dry baking mix such as those for bread, cake, and cookies. Besides dry goods, a base consumable can be a liquid, such as milk, syrup, salad dressing, and even liquid condiments (e.g. ketchup, mustard, steak sauces, etc.) or marinates that have oil, vinegar, soy sauce, etc. Semi-solids such as, for example, gelatins and yogurts can be included as a base consumable; as well as solids such as fruits and meats (e.g. poultry, fish).

Base consumables appropriate for sweetening can be packaged for combination with a sweetener or a flavorant. Natural or artificial sweeteners can be used. Suitable flavorants for enhancing a pastry, a dietary supplement, a dry good, medicines, a syrup or other typically sweetened food product include, but are not limited to, chocolate, vanilla, fruits (e.g. strawberry, banana, peach, orange, cherry, blueberry, raspberry, mango, apple, pineapple, grape, etc.), peanut butter, mint, caramel, cinnamon, mocha, and many more palatable and popular flavors, and combinations thereof. As described above, a kit can include an additive such as a preservative, texturizer, colorant, and the like. Combinations of these additives can be provided in kits according to the invention.

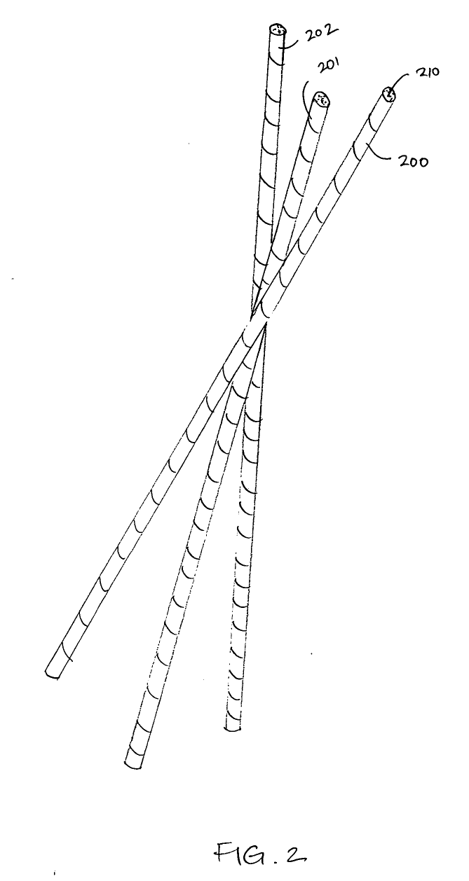

In one embodiment according to the invention, a nutritional or dietary supplement product can be provided having (1) an unflavored or plain solid, powder or liquid base component packaged in its own container, and (2) at least one flavor packet attached to the dietary supplement container. The dietary supplement product can include, among other things, proteins, peptides, amino acids, and combinations thereof. The base consumable can be for example, a protein powder or nutrition shake mix, and the flavor packet can be a sealed package or pouch. One suitable package configuration for a flavor powder is a sealed but openable straw-like package 200, as illustrated in FIG. 2. In another aspect, the product can include a plurality of flavor packets, preferably equal to the amount of servings in the container (of base consumable). Packaged in the exemplary configuration of a filled straw 200, flavorant 210 can be conveniently bundled and packaged in a kit. A plurality of packages 200, 201, 202 can be provided. Having more than one type of flavor packet, 200-202, advantageously offers the consumer a way to tailor his or her choice of flavor of the product, from serving to serving. In an alternative configuration, the base item's container can have a holder in which the consumer places flavor packets he or she chooses from an array of packets. The holder can be dimensioned to fit a number of packets equal to the total number of servings of the container of dietary supplement. Such a customized kit allows a consumer to thereby enjoy an unlimited variety of flavors by merely purchasing one container of a base consumable.

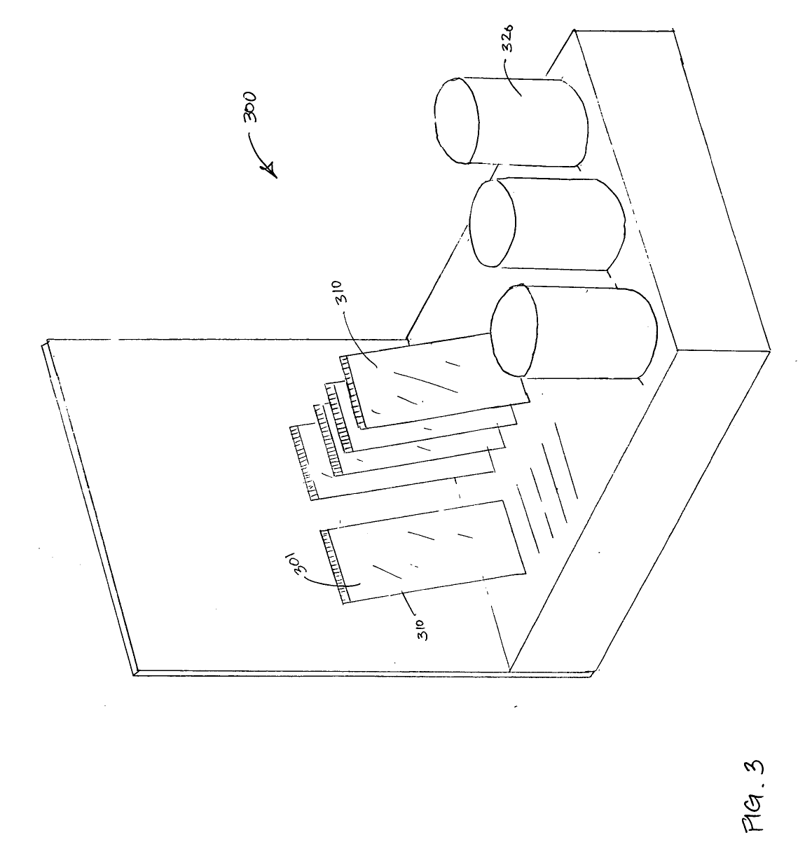

FIG. 3 provides a further embodiment according to the invention, whereby a system such as a rack 300 (e.g. point of purchase, display rack, etc) or array of additives and base items are presented. Additives 301 can be provided in individual packages 310 and be displayed in close proximity or adjacent to corresponding base item(s) 320. Base item 320 can include more than one portion or serving. Various additives can be provided such as those described above. A user can therefore advantageously pick and choose which additive(s) from system 300 to add to complete a custom kit, based on his or her own preference and discretion. Within package 310, pre-measured portions (not shown) can be included. This feature can be particularly advantageous, as it allows a user, consumer or purchaser to enjoy the enhanced product with one additive, or in various combinations by merely combining one or more types of additives, and in various amounts if desired. Thus, by choosing a multitude of additive types, kinds, versions, etc., up to an unlimited number of combinations can be made from one base consumable. In particular, depending on the number of additives chosen, the number of different combinations or variations resulting from a base combined with at least one additive equals the factorial value calculated from the number of additives.

In a method of the invention, a customized or build-your-own product selling (or purchasing, whichever party is utilizing such method) methodology can advantageously be implemented. For example, a method of selling a customizable nutritional supplement drink can include: offering a nutritional supplement base, where the base includes at least one of a protein, carbohydrate, electrolyte, amino acid, nutraceutical, nutrient, pharmaceutical or combination thereof; offering one or more individual flavorants that; and allowing a user to choose at least one flavorant from the set of flavorants; wherein the flavorants are admixable to the base at a time later after the user obtains the base and flavorant to create a flavored nutritional supplemental drink.

It is contemplated that a retailer, distributor, warehouser or other seller or marketer can construct or use a display area having base consumables along with a display of additive packages. The system would a consumer or user to choose one or more additive packages for combination with a base. Optionally, the additives can be carried by or positioned on to a base item or its container. The carrier or holder can be pre-attached to the consumable package, or it can be attached at the point of assembly by the consumer or user.

It is also in accordance with an embodiment of the invention to provide kits and systems that can be customized and purchased, for example, via the internet (e.g., web-based), where a consumer can select the base consumable or food item and then pick one or more additives to be packaged into a kit for delivery to the purchaser. This may require a merchant to set up a methodology whereby frames present base consumables offered for sale, as well as additives, in various amounts and types that correspond to the base consumable.

By keeping a base consumable and at least one additive separate until, for example, just prior to consuming the product, a consumer, purchaser or user can advantageously make customized products to suit his or her desires. Furthermore, the user or consumer is not limited to certain variations of a product, but rather, can be empowered to make an unlimited number of variations and combinations. Practicing certain methods according to the invention can also provide advantages to a manufacturer, distributor, merchants, warehousers, and other entities, by allowing for economies of scale in production, packaging, and inventorying. as well as reduced potential spoilage, increased efficiency, or less shelving space.

A number of embodiments of the invention have been described. Nevertheless, it will be understood that various modifications may be made without departing from the spirit and scope of the invention. Accordingly, other embodiments are within the scope of the following claims.

What is claimed:

1. A method of offering customizable food comprising:
providing a base item;
providing an array of additives compatible for combining with the base item, wherein addition of at least one additive from said array of additives to said base item alters a characteristic of the base item; and
allowing a user to obtain the base item and at least one additive from the array, wherein the quantity of additives in said array of additives is a number greater than one.

2. The method according to claim 1, wherein the offering of customizable food is accomplished at a retail level point-of-sale.

3. The method according to claim 1, wherein the offering of customizable food is accomplished as a web-based sale.

4. The method according to claim 1, wherein an additive from said array of additives is combinable with said base item at a time after the user obtains the additive and base item.

5. The method according to claim 1, wherein the base item is provided in an amount sufficient for a plurality of servings.

6. The method according to claim 1, wherein the base item is provided in bulk, and the method further comprises allowing a user to obtain any portion of the base item from said bulk.

7. The method according to claim 6, further comprising packaging individual servings of the base item in separate packages.

8. The method according to claim 1, further comprising packaging the additives in individual packages.

9. The method according to claim 1, wherein the combination of an additive to a base item alters a characteristic selected from a group consisting of taste, color, shelf life, size, texture, ingredient concentration, and combinations thereof.

10. A method of selling a customizable nutritional supplement drink comprising:
offering a nutritional supplement base comprising at least one of a protein, carbohydrate, electrolyte, amino acid, nutraceutical, nutrient, pharmaceutical or combination thereof;
offering a plurality of individual flavorants;
allowing a user to choose at least one flavorant among said plurality of flavorants; wherein the chosen flavorant is admixable to said base at a time later after the purchaser obtains said base and flavorant to create a flavored nutritional supplemental drink.

11. The method according to claim 10, wherein said base is substantially unflavored prior to admixture of a flavorant.

12. The method according to claim 10, further comprising
allowing the user to obtain said base in a quantity sufficient for a plurality of individual servings and said at least one flavorant in a quantity sufficient for at least said plurality of individual servings of said base.

13. The method according to claim 10, wherein at least two of said plurality of individual flavorants are combinable.

14. A system for presenting customizable food, the system comprising: at least one base item;
a plurality of additives compatible for admixture with the base item;
a display construction having a first area configured to hold the base item; and a second area configured to hold the plurality of additives, wherein the base item and at least one of said plurality of additives is obtainable from said system for combination at a later time after obtaining said base item and said at least one additive.

15. The system of claim 14, wherein the first and second areas are within a commonly defined space.

16. The system of claim 14, wherein the base item is provided in bulk.

17. The system of claim 14, wherein the base item is packaged in a structure comprising an attachment member sized to hold at least one additive chosen from the plurality of additives.

18. The system of claim 14, where said plurality of additives comprises more than one type of additive.

19. The system of claim 14 wherein said plurality of additives is provided in bulk.

20. The system of claim 14, wherein the plurality of additives are provided in individual packages.

21. The system of claim 20, wherein the base item is sized for a plurality of servings and the number of individual packages of the additives corresponds to at least the same number of servings of the base item.

22. The system of claim 14, wherein the base item is sized for a plurality of servings, and the additives are provided in a multi-pack comprising separately contained amounts of additives, said amounts sufficient for combining with a single serving of the base item.

23. A method of providing a system for presenting customizable food, the method comprising:
providing at least one base item;
providing a plurality of additives compatible for combination with the base item;
providing a display construction having a first area configured to hold the base item; and a second area configured to hold the plurality of additives, wherein the base item and at least one of said plurality of additives is obtainable from said system for combination at a later time after obtaining said base item and said at least one additive; and
providing the display construction, the at least one base item, and the plurality of additives as a system.

24. A method of making a customizable food comprising:
obtaining a base item;
obtaining at least one additive compatible for combining with the base item; and
combining the at least one additive to said base item to alter a characteristic of the base item.

25. The method according to claim 24, further comprising
obtaining at least two additives compatible for combining with each other and with the base item, wherein the number of different combinations resulting from a base item combined with at least one additive equals the factorial value calculated from said number of additives.

26. A kit for making a nutritional supplement comprising:
a dietary supplement product; and
at least one additive, wherein the additive is packaged separately from the dietary supplement product.

27. The kit of claim 26, wherein the at least one additive when combined with the dietary supplement product, at a time after the manufacture of both the dietary supplement product and the additive, alters a characteristic of the dietary supplement product.

28. The kit of claim 26, wherein the additive is a flavorant, and when combined with said dietary supplement, provides a flavored blend.

29. The kit of claim 28, wherein the flavorant is selected from a group consisting of vanilla, chocolate, butterscotch, peanut butter, mocha, strawberry, banana, peach, orange, cherry, blueberry, raspberry, mango, apple, pineapple, grape, mint, caramel, cinnamon and combinations thereof.

30. The kit of claim 26, wherein the dietary supplement product comprises a material selected from a group consisting of proteins, peptide, amino acids, carbohydrates, electrolytes, herbs, nutraceuticals, nutrients, pharmaceuticals, and combinations thereof.

31. The kit of claim 26, wherein the additive comprises a material selected from a group consisting of proteins, peptide, amino acids, carbohydrates, electrolytes, herbs, nutraceuticals, nutrients, pharmaceuticals, and combinations thereof.

32. The kit of claim 26, wherein the dietary supplement product is a powder, liquid, or solid.

33. The kit of claim 26, further comprising a plurality of individually packaged additives.

34. The kit of claim 33, wherein the dietary supplement product is apportionable into single servings and the number of individually packaged additives is equal to at least the number of single servings of the dietary supplement product.

35. A kit for making a customizable food comprising:
a base item; and
at least one additive, wherein the at least one additive is packaged separately from the base item, and when combined with the base item, at a time after the manufacture of both the base item and the additive, alters a characteristic of the base item.

36. The kit of claim 35, wherein the at least one additive is selected from a group consisting of a colorant, a flavorant, a texturizer, a preservative, and combinations thereof.

37. The kit of claim 35, wherein the characteristic altered by the at least one additive is selected from a group consisting of taste, color, size, shelf life, smoothness, ingredient concentration, and combinations thereof.

38. The kit of claim 35, wherein the kit comprises a plurality of packaged additives.

39. The kit of claim 35, wherein the base item is contained in a first package and the additive package is held adjacent to said first package.

40. The kit of claim 35, wherein the base item and the at least one additive package are combined into one package.

41. The kit of claim 35, wherein the base item is in a form selected from a group consisting of a solid, semi-solid, liquid, or powder.

42. The kit of claim 35, wherein the base item is contained in a package, said package comprising a holder adapted to hold the at least one additive package.

43. The kit of claim 42, wherein the holder is integral with said base item package.

44. A method of offering a product:
providing a first display of a plurality of base products;
providing a second display of a plurality of packages, each package comprising at least one additive that alters a characteristic of the base product when the additive is combined with the base product;
providing a holder connectable to at least one base product of said plurality of base products, said holder dimensioned to fit at least one package of additive.
